(19) United States
(12) Patent Application Publication
(10) Pub. No.: US 2015/0369122 A1
(43) Pub. Date: Dec. 24, 2015

(54) METHOD FOR CLEANING A COMBUSTION CHAMBER OF AN INTERNAL COMBUSTION ENGINE, AND INTERNAL COMBUSTION ENGINE

(71) Applicant: MTU FRIEDRICHSHAFEN GMBH, Friedrichshafen (DE)

(72) Inventor: Bernhard STILLER, Schlier (DE)

(73) Assignee: MTU Friedrichshafen GmbH, Friedrichshafen (DE)

(21) Appl. No.: 14/764,481

(22) PCT Filed: Dec. 19, 2013
(86) PCT No.: PCT/EP2013/003868

§ 371 Date: Jul. 29, 2015

(30) Foreign Application Priority Data
Jan. 30, 2013 (DE) 10 2013 201 532.1

(51) Int. Cl. F02B 77/04

(52) U.S. Cl. CPC F02B 77/04

(57) ABSTRACT

A method for cleaning a combustion chamber of an internal combustion engine, having the following steps: introducing a gaseous substance into a cooling device, wherein the gaseous substance has, at least upstream of the cooling device, a relative humidity of greater than 0%; cooling the substance in the cooling device to below a dewpoint, such that water precipitate is formed; introducing the substance and the precipitate into a combustion chamber of the internal combustion engine; performing a combustion reaction in the combustion chamber; and discharging residues from the combustion chamber.

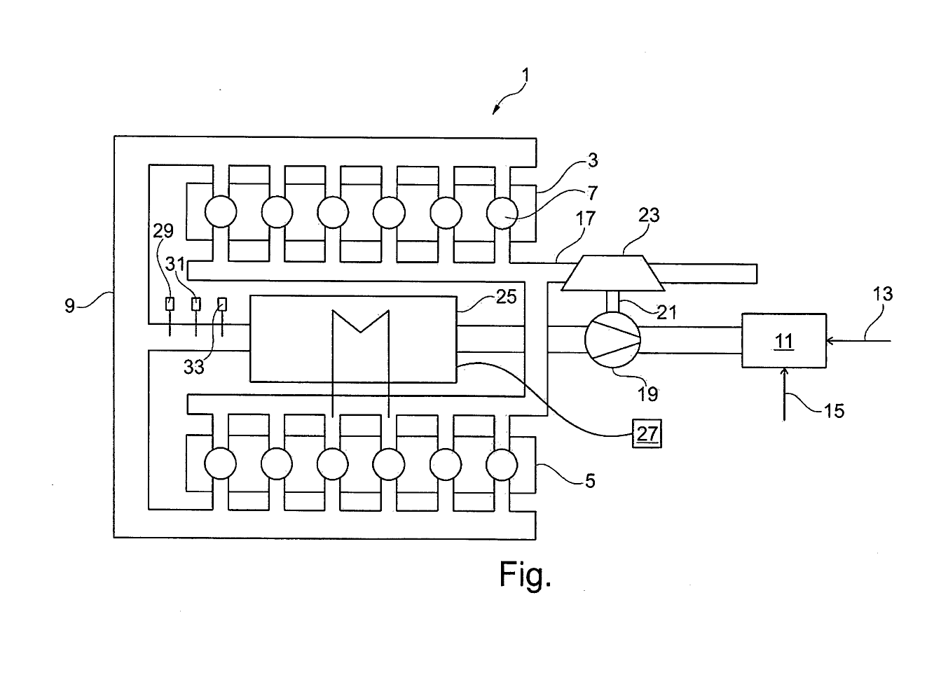

The invention relates to a method for cleaning a combustion chamber of an internal combustion engine, as per claim 1, and to an internal combustion engine, as per the preamble of claim 9.

In internal combustion engines, there is typically the problem that, over time, as a result of combustion reactions taking place continuously in at least one combustion chamber, deposits form in the combustion chamber, which deposits comprise for example oil ash and/or contaminants supplied with the combustion air. In particular in the case of internal combustion engines designed as gas engines, such deposits can lead to knocking, which in turn leads to a reduction in maximum power and a shortening of the service life of the internal combustion engine. It is therefore necessary for internal combustion engines of said type to be cleaned, or for the combustion chambers to be freed from deposits, at predetermined intervals or else in accordance with demand. For this purpose, provision is typically made for the internal combustion engine to be shut down and disassembled, and for the deposits in the combustion chambers to be mechanically removed. This is highly cumbersome, in particular time-consuming and expensive, and means that the internal combustion engine has to be put out of action for the time taken to perform the cleaning, which in turn leads to downtime costs. The British patent application GB 2 357 318 A discloses a method by which it is sought to prevent the formation of deposits in the combustion chamber of an internal combustion engine in the first place. For this purpose, water is introduced, in particular injected, into the combustion chamber and evaporated there. In this case, said water has the effect in particular of reducing the combustion temperature, thus preventing the formation of silicon oxides, which otherwise lead to deposits in the combustion chamber. A disadvantage of this approach is that it requires a complex injection apparatus for the introduction of the water.

The invention is based on the object of providing a method and an internal combustion engine which, in particular, permit simple and inexpensive cleaning of the at least one combustion chamber of the internal combustion engine for removal of deposits.

The object is achieved through the provision of a method having the steps of claim 1. Here, a gaseous substance is introduced into a cooling device. The gaseous substance has, at least upstream of the cooling device, a relative humidity of greater than 0%, that is to say it comprises a certain non-zero concentration of water vapor. In the cooling device, the substance is cooled to below a dewpoint. Water precipitate is thus formed. The substance comprising the precipitate is introduced into a combustion chamber of the internal combustion engine, and a combustion reaction is performed in the combustion chamber. As a result of the increase in pressure and temperature during the combustion reaction, the water comprised in the precipitate evaporates, wherein the phase transition results in particular in an abrupt change in volume. This causes the coating or deposits to flake off from a combustion chamber wall. Residues are subsequently discharged from the combustion chamber. In this case, the expression “residues” encompasses both exhaust gases generated during the combustion reaction but also the flaked-off coatings, which can in particular exit the combustion chamber together with the exhaust gases through an outlet valve. The combustion chamber is thus cleaned in a highly effective manner. The method is inexpensive as it does not require a complex apparatus for the introduction of water. Rather, the already existing moisture in the gaseous substance is preferably used to form a precipitate in a cooling device which is typically provided in any case, which precipitate subsequently serves for the cleaning of the at least one combustion chamber. In the context of the method, it is also not necessary for the internal combustion engine to be disassembled and mechanically cleaned. Rather, the cleaning can be performed during the operation of the internal combustion engine, and in particular at full power. Owing to the efficiency of the cleaning method, maximum power is available over a longer operating period, and the component-damaging effect of knocking can be reduced to a minimum.

The method may additionally have the effect that, owing to the water which evaporates in the combustion chamber, lower combustion temperatures prevail, which has a positive effect on the emissions of the internal combustion engine. Likewise, water evaporating in the combustion chamber may preferably have the effect that silicon oxides do not form or form only to a lesser extent, such that the formation of new deposits is prevented or at least slowed.

In the context of the method, it is possible for the precipitate to be formed in the cooling device. It is alternatively or additionally possible for the precipitate to form in a feed line via which the gaseous substance is conducted from the cooling device to the at least one combustion chamber. It is preferably the case that, in the cooling device and/or in the feed line, a mist of water droplets is formed in a gaseous residual substance.

In the context of the method, a temperature in the cooling device is preferably targetedly selected such that the relative humidity of the gaseous substance increases to a value of over 100% in the cooling device and/or downstream of the cooling device. This is an approach which is typically intentionally avoided in the case of known internal combustion engines and methods for the operation thereof. By contrast, in customary cooling devices, the temperature is typically always selected such that specifically no precipitate forms in the cooling device or downstream thereof. For example, a temperature in a corresponding cooling device is selected to be higher in the case of internal combustion engines which are operated in tropical regions with relatively high air humidity than in the case of internal combustion engines which are operated in regions with relatively low air humidity. By contrast, in the context of the method, the possibility of forming precipitate from the moisture in the gaseous substance in or downstream of the cooling device through targeted setting of the temperature of said cooling device is intentionally utilized to clean the at least one combustion chamber of the internal combustion engine.

A method is preferred which is characterized in that a gas mixture composed of combustion air and a fuel is used as gaseous substance. In this case, a mixture cooler is preferably used as cooling device, which mixture cooler is preferably arranged downstream of a gas mixer in which combustion air is mixed with the fuel, preferably a gas. In this context, an internal combustion engine which operates on the basis of the Otto-cycle principle is particularly preferred. In the context of the invention, in this case, the residual moisture in the combustion air and possibly also the residual moisture in the fuel are utilized to generate precipitate by way of the mixture cooler, which precipitate subsequently serves for cleaning the combustion chamber.

A method is also preferred which is characterized in that combustion air is used as gaseous substance. In this case, a combustion air cooler is preferably used as cooling device. This embodiment of the method is particularly preferably implemented in conjunction with an internal combustion engine which operates on the basis of the diesel principle, and/or in which a fuel is introduced directly into the combustion chamber without previously being mixed with the combustion air. In this embodiment of the method, the relative humidity of the combustion air is utilized, and in the combustion air cooler or downstream thereof, a precipitate is generated which is subsequently used for cleaning the combustion chamber.

A method is also preferred which is characterized in that recirculated exhaust gas of the internal combustion engine is used as gaseous substance. In this case, the internal combustion engine preferably has an exhaust-gas recirculation arrangement via which exhaust gas is supplied together with the combustion air to the at least one combustion chamber, in particular in order to lower emissions of the internal combustion engine or increase the efficiency of said internal combustion engine. In this embodiment of the method, an exhaust-gas recirculation cooler is preferably used as cooling device. It is alternatively or additionally possible for a combustion air cooler to be used as cooling device, in which combustion air cooler the recirculated exhaust gas is cooled together with the combustion air. It is thus possible to utilize the relative humidity of recirculated exhaust gas in order to generate precipitate in or downstream of an exhaust-gas recirculation cooler and/or a combustion air cooler, which precipitate is subsequently used for cleaning the combustion chamber.

A method is also preferred which is characterized in that the gaseous substance is compressed upstream of the cooling device. A compressor is preferably provided for this purpose. It is alternatively or additionally possible for a turbocharger to be used for compressing the gaseous substance. The gaseous substance is preferably compressed before being supplied to the cooling device. In this way, it is possible, by means of the cooling device, to dissipate heat that is generated during the compression, and to thus in particular increase a charge of the at least one combustion chamber.

A method is also preferred which is characterized in that the temperature in the cooling device is lowered to below the dewpoint once. This means that, during normal operation of the internal combustion engine, the temperature in the cooling device is kept above the dewpoint, which corresponds to the conventional approach as described above. Only in order to clean the internal combustion engine is the temperature in the cooling device lowered to below the dewpoint once, at a predetermined point in time, after a predetermined number of operating hours, after a predetermined total power output of the internal combustion engine has been reached, or after a motor vehicle which is driven by the internal combustion engine has covered a predetermined travelling distance, in order to clean the at least one combustion chamber. In particular, it is possible for the method to be implemented upon or immediately after starting of the internal combustion engine.

It is alternatively possible for the temperature in the cooling device to be lowered to below the dewpoint periodically. In particular, this may be performed regularly after a restart of the internal combustion engine, after a predetermined time period, after a predetermined number of operating hours, after a predetermined interval of a power output of the internal combustion engine, or after a motor vehicle which is driven by the internal combustion engine has covered a predetermined travelling distance.

It is alternatively possible for the temperature in the cooling device to be lowered to below the dewpoint permanently, or to be kept permanently at a value below the dewpoint. This not only yields continuous cleaning of the at least one combustion chamber, but also gives rise in particular to the advantages, already described above, with regard to reduced or even eliminated formation of new deposits.

Finally, it is possible for the temperature in the cooling device to be lowered to below the dewpoint in accordance with demand. In this case, it is preferably provided that the formation of deposits is detected indirectly or directly by suitable means, wherein the cleaning method is implemented, and consequently the temperature is lowered to below the dewpoint, if the deposits exceed a predetermined amount.

A method is also preferred which is characterized in that at least one variable of the substance is measured upstream or downstream of the cooling device. In this case, the dewpoint of the substance is determined from the at least one variable. In this way, it is possible for the temperature in the cooling device to be targetedly kept either above or below the dewpoint at all times depending on whether the method for combustion chamber cleaning is to be implemented or not implemented. In this way, it is also possible for the internal combustion engine to be operated under different ambient conditions, in particular in regions or at times of different air humidity, with targeted implementation of the method or intentional non-implementation of the method.

In this context, a method is preferred which is characterized in that the variable from which the dewpoint is determined is selected from a group comprising a pressure, a temperature and a relative humidity of the substance. It is particularly preferable for the pressure, the temperature and the relative humidity of the substance to be measured, wherein the dewpoint is determined from all of the measured values together. It is then very reliably possible at all times, and under any usage conditions, for the temperature in the cooling device to be selected in targeted fashion such that the method for combustion chamber cleaning is either implemented or intentionally not implemented.

The object is also achieved through the provision of an internal combustion engine having the features of claim 9. Said internal combustion engine comprises at least one combustion chamber and a cooling device for cooling a substance that can be supplied to the combustion chamber. The internal combustion engine is characterized by a control device which is designed for determining a dewpoint of the substance for supply to the combustion chamber, wherein the control device is designed, and operatively connected to the cooling device, such that a temperature in the cooling device can be lowered to below the dewpoint by way of said control device. In particular, the internal combustion engine is preferably designed for implementing a method as per one of the embodiments described above.

The internal combustion engine is preferably in the form of a reciprocating-piston engine, wherein the method is implemented during normal operation of the internal combustion engine, and in particular can even be implemented under full load, wherein either a gas mixture of combustion air and a fuel, the combustion air on its own, recirculated exhaust gas on its own, or a mixture of recirculated exhaust gas and combustion air is cooled to below the dewpoint by way of the cooling device when the method is implemented.

The internal combustion engine preferably comprises a feed line through which the substance can be conducted from the cooling device to the at least one combustion chamber. The control device is preferably designed for controlling the cooling device, and is operatively connected to the latter such that the temperature in the cooling device can be controlled and/or regulated by way of the control device.

The control device is preferably in the form of, or comprised by, an engine control unit. In the control device there is preferably implemented an algorithm by which a dewpoint of the substance that can be supplied to the combustion chamber can be determined, and/or a setpoint temperature for the cooling device can be calculated, which may lie below or even above the dewpoint of the substance depending on whether or not the method for combustion chamber cleaning is to be implemented.

An internal combustion engine is also preferred which is characterized in that it has at least one detection means provided for detecting at least one variable from which the dewpoint of the substance for supply to the combustion chamber can be determined. The detection means is operatively connected to the control device for determining the dewpoint.

In an exemplary embodiment, the detection means is in the form of a pressure sensor which is arranged upstream or downstream of the cooling device. In another exemplary embodiment, the detection means is in the form of a temperature sensor which is arranged upstream or downstream of the cooling device. In a further exemplary embodiment, the detection means is in the form of a humidity sensor which is arranged upstream or downstream of the cooling device. In yet another exemplary embodiment, it is preferable for a pressure sensor, a temperature sensor and a humidity sensor to be provided as detection means, which may each be arranged upstream or downstream of the cooling device.

The invention will be discussed in more detail below on the basis of the drawing. Here, the single FIGURE is a schematic illustration of an internal combustion engine which is set up for implementing the method.

The FIGURE is a schematic illustration of an exemplary embodiment of an internal combustion engine 1. The latter is in this case in the form of a twelve-cylinder V-configuration engine with a first cylinder bank 3 and a second cylinder bank 5, wherein each of the cylinder banks 3, 5 comprises six combustion chambers, wherein here, for better clarity, only one of said combustion chambers is denoted by the reference sign 7. A gaseous substance is supplied to the combustion chambers 7 via a feed line 9. In the exemplary embodiment illustrated, said substance is in the form of a mixture which is prepared in a gas mixer 11 from combustion air 13 and a fuel 15.

In a known manner, a combustion reaction takes place in the combustion chambers 7, wherein residues, in particular exhaust gases, are generated which are discharged via a discharge line 17.

Downstream of the gas mixer 11, the gas mixture is compressed in a compressor 19 which, in this case, is driven via a shaft 21 by a turbine 23 which, in turn, is driven by the exhaust gas flowing in the discharge line 17. In the illustrated exemplary embodiment of the internal combustion engine 1, a turbocharger is thus provided which comprises the compressor 19, the shaft 21 and the turbine 23. It may alternatively be provided that, to compress the gas mixture, a supercharger is provided downstream of the gas mixer 11, which supercharger is driven for example by a crankshaft of the internal combustion engine or by an auxiliary motor.

Downstream of the compressor 19 there is arranged a cooling device 25 through which the gas mixture flows, wherein said gas mixture is cooled after the compression. In this way, it is generally possible to increase a charge of the combustion chambers 7.

In the exemplary embodiment illustrated, the cooling device is controlled by a control device 27; in particular, a temperature in the cooling device 25 is controlled and/or regulated by way of the control device 27.

In the illustrated exemplary embodiment, in the feed line 9 downstream of the cooling device 25, there are provided three detection means for detecting a variable of the gas mixture, from which variable a dewpoint of said gas mixture can be determined. Said detection means are in this case a pressure sensor 29, a temperature sensor 31 and a humidity sensor 33. The pressure sensor 29, the temperature sensor 31 and the humidity sensor 33 are preferably operatively connected to the control device 27 such that, on the basis of the values measured by way of the sensors 29, 31, 33, said control device can determine a dewpoint of the gas mixture and control and/or regulate the temperature in the cooling device 25 such that said temperature lies either below or above the dewpoint. For better clarity, the corresponding operative connections are not explicitly illustrated here.

If the combustion chambers are to be cleaned, the temperature in the cooling device 25 is lowered in targeted fashion to below the dewpoint of the gas mixture by the control device 27, such that water precipitate is formed in the cooling device 25 and/or downstream thereof in the feed line 9. Said water precipitate is introduced via the feed line 9, together with the gas mixture, into the combustion chambers 7, where the precipitate abruptly evaporates as a result of the increase in pressure and temperature owing to the combustion reaction performed in the combustion chambers. Deposits on walls of the combustion chambers 7 are thus caused to flake off. Said deposits can be discharged together with the exhaust gas via the discharge line 17. If the combustion chambers 7 are not to be cleaned, the temperature in the cooling device 25 is, by way of the control device 27, controlled and/or regulated to a value above the dewpoint of the gas mixture.

Instead of the cooling device 25, which in this case is in the form of a mixture cooler, it is possible in another exemplary embodiment of the internal combustion engine 1 for a combustion air cooler to be used for implementing the method, wherein combustion air is used as gaseous substance. In another exemplary embodiment of the internal combustion engine 1, it is possible for an exhaust-gas recirculation cooler or a combustion air cooler to be used in order to cool recirculated exhaust gas of the internal combustion engine separate from or together with the combustion air.

If, in one exemplary embodiment of the internal combustion engine, no detection means for detecting at least one variable are provided for determining the dewpoint of the gaseous substance, it is possible for the control device 27 for implementing the method to be programmed to a typical value of the relative humidity of the gaseous substance supplied to the combustion chambers 7, said value then being dependent on the usage conditions of the internal combustion engine 1. The control device 27 is then for example programmed differently for use in tropical region with a high air humidity than for use in regions in which a relatively low air humidity prevails. This possibility is also encompassed by the wording that the control device is designed for determining the dewpoint, wherein in this case, the dewpoint is determined by way of the programming or by virtue of a memory being read out.

By means of the control device 27, it is possible for the method to be implemented once, periodically, permanently and/or in accordance with demand, and consequently for the temperature in the cooling device 25 to be lowered to below the dewpoint of the gaseous substance supplied to the combustion chambers 7 once, periodically, permanently and/or in accordance with demand.

It is evident that the method uses only components of the internal combustion engine 1 that are provided in any case. In particular, there is no need for an additional injection device for water or for a special water reservoir to be carried on board either, because the water used for cleaning the combustion chambers is obtained from the humidity of the gaseous substance supplied. The method is at the same time highly efficient and can be implemented during the operation of the internal combustion engine 1, even under full load. Cumbersome and expensive cleaning by dismantling the internal combustion engine 1 and mechanically removing deposits is thus rendered unnecessary.

Altogether, it is evident that the method and the internal combustion engine provide a particularly inexpensive, time-saving and effort-saving means for cleaning the combustion chambers 7 for removal of deposits, and ultimately also for increasing the service life and maximum power of the internal combustion engine 1.

1-10. (canceled)

11. A method for cleaning a combustion chamber of an internal combustion engine, comprising the steps of:
introducing a gaseous substance into a cooling device, wherein the gaseous substance has, at least upstream of the cooling device, a relative humidity of greater than 0%;
cooling the substance in the cooling device to below a dewpoint, such that water precipitate is formed;
introducing the substance comprising the precipitate into a combustion chamber of the internal combustion engine;
performing a combustion reaction in the combustion. chamber;
and discharging residues from the combustion chamber.

12. The method as claimed in claim 11, wherein the gaseous substance is a gas mixture composed of combustion air and a fuel.

13. The method as claimed in claim 12, wherein the cooling device is a mixture cooler

14. The method as claimed in claim 11, wherein the gaseous substance is combustion air.

15. The method as claimed in claim 14, wherein the cooling device a combustion air cooler.

16. The method as claimed in claim 11, wherein the gaseous substance is recirculated exhaust gas of the internal combustion engine,

17. The method as claimed in claim 16, wherein the cooling device is an exhaust-gas recirculation cooler or a combustion air cooler.

18. The method as claimed in claim 11, including compressing the gaseous substance upstream of the cooling device.

19. The method as claimed in claim 18, including compressing the gaseous substance with a compressor or a turbocharger.

20. The method as claimed in claim 11, including lowering the temperature in the cooling device to below the dewpoint once, periodically, permanently or in accordance with demand.

21. The method as claimed in claim 20, including lowering the temperature upon starting the internal combustion engine.

22. The method as claimed in claim 11, including measuring at least one variable of the substance upstream or downstream of the cooling device, and determining the dewpoint from the at least one variable.

23. The method as claimed in claim 22, wherein the variable is selected from the group consisting of pressure, temperature and relative humidity of the substance.

24. An internal combustion engine, comprising: at least one combustion chamber; a cooling device for cooling a substance that is supplied to the combustion chamber; and a control device designed for determining a dewpoint of the substance for supply to the combustion chamber, wherein the control device is constructed and operatively connected to the cooling device so that a temperature in the cooling device is lowerable to below the dewpoint by the control device.

25. The internal combustion engine as claimed in claim 24, further comprising at least one detector that detects at least one variable from which the dewpoint of the substance for supply to the combustion chamber is determinable, wherein the detector is operatively connected to the control device for determining the dewpoint.
